(19) United States
(12) Patent Application Publication
(10) Pub. No.: US 2009/0208619 A1
(43) Pub. Date: Aug. 20, 2009

(54) Selective removal of ions from aqueous liquids

(76) Inventor: Thaiyalbagam Somasundaram, Culver City, CA (US)

Correspondence Address: Lawrence Edelman, The Law Office of Lawrence Edelman, 130 San Aleso Avenue, San Franisco, CA, 94127, US

(21) Appl. No.: 12/378,448

(22) Filed: Feb. 13, 2009

Related U.S. Application Data
(60) Provisional application No. 61/065,926, filed on Feb. 16, 2008.

(51) Int. Cl. A23L 2/74; A23L 2/78

(52) U.S. Cl. 426/271; 426/490

(57) ABSTRACT

A process that selectively removes anions and cations from dietary liquids is described. This process uses ion exchange resins and equilibrium dialysis to remove such chemicals as potassium and phosphate from fruit juices, dairy products and other dietary liquids, without removing other essential nutrients.

### CROSS REFERENCE TO RELATED CASES

This application claims priority to U.S. Provisional Application Ser. No. 61/065,926, filed Feb. 16, 2008, which provisional application is incorporated herein by reference as if fully set forth here in its entirety.

### BACKGROUND OF THE INVENTION

1. Field of the Invention

This invention relates generally to equilibrium dialysis of fluids, and more particularly to the equilibrium dialysis of dietary liquids to remove potassium without removing other valuable nutrients.

2. Description of the Related Art

Renal insufficiency imposes dietary restrictions on patients with end stage renal disease (ESRD). Such restrictions include diets containing low levels of potassium and phosphorous in order to avoid hyperkalemia and hyperphosphatemia respectively. Although phosphate binders (calcium and non-calcium based) are regularly taken by ESRD patients to exclude phosphate, and occasionally potassium binders such as kayexalate taken to reduce potassium intake, it is preferable that these ions be removed from the diets before being consumed. Certain fruit juices that are rich in minerals and vitamins needed for healthy living have higher amounts of potassium. Renal patients who are restricted from drinking these juices due to the high potassium content have to depend on other sources for vitamins and minerals even though these juices offer essential nutrients for healthy people. Similarly, high phosphorous in dairy products such as milk cast limitations on the intake of essential nutrients for ESRD patients. Selectively removing potassium and phosphates from these products would be of great help to renal patients. The present invention does this without causing the removal of other necessary nutrients.

The techniques of column chromatography using ion exchange resins have been applied to remove ions from liquid samples. Based on this principle ion exchange resins were used to reduce the levels of certain anions and cations from liquid diets. Pretreatment of apple and grape juices with Zerolith, a calcium ion exchange resin, has been shown to bring down potassium content (Van Kamp, G. J., Bakker, W., and Rosier, J.G.M.C., Removal of potassium from fruit juices by ion exchange. Brit. Med. J (1975) March 1, 512-513). The level of potassium in dietary liquids such as fruit juices, milk, and infant-formula was significantly reduced when treated with sodium polystyrene sulfonate (Bunchman, T., Wood, E. G, Schenck, M. H, Weaver, K. A, Klein, B. L, and Lynch, R. E Pretreatment of formula with sodium polystyrene sulfonate to reduce dietary potassium intake. Pediatr. Nephrol (1991) 5 29-32). However, these authors have observed disproportionate increase in the levels of sodium after the treatment and reduced levels of calcium and magnesium. Similar studies using calcium polystyrene sulfonate (calcium resonium) have shown significant reduction in the levels of potassium (Schroder, C. H, vandenBerg, A. M. J, Willems, J. L., and Monnens, L. A. H., Reduction of potassium in drinks by pretreatment with calcium polystyrene sulfonate. Eur. J. Pediatr (1993) 152 263-254). Thus, ion exchange resins have been shown to be of great use in reducing specific ions from liquid diets.

More recently, in U.S. Pat. No. 6,387,425 (Kinoshita et al.) techniques were described for removing potassium from fruit juices. These techniques involved the use of “H” type cationic resins to remove potassium and the subsequent addition of calcium carbonate to correct the pH and improve the taste. Another prior art proposal, described in pending US patent application 20060147559 (Maurer et al.) involves the use of an ion exchange membrane and an applied potential in an electrolysis cell to selectively capture the cations. The resultant juice is again supplemented with calcium because electrodialysis removed not only the potassium but also other beneficial cations

The major drawback in using these ion exchange resin approaches is the removal of the resins from the liquids in the batch processes. Secondly, turbid juices like orange, tomato and vegetable juices pose problems in columnar processes (Bunchman et al 1991, supra at paragraph 0004). Further, there is a loss of other ions that must be replaced by supplementation after the ion exchange treatment. Similarly the process of electrolysis removes not only the potassium but also other cations such as calcium which have to be replenished. And finally, the use of resins necessitates the filtration of the juices after treatment to remove the resins. This becomes difficult for turbid liquids such as orange juice, tomato juice or vegetable juices (See Van Kamp et al 1975, supra at paragraph 0004).

### SUMMARY OF THE INVENTION

By way of this invention an improved method is provided to selectively exclude the cations as well as anions in dietary liquids such as fruit juices, milk, infant formula etc. without altering their nutrient contents. Although this method uses ion capturing or exchanging compounds (see prior art and literature), the dietary liquids to be consumed will neither be treated with these compounds directly nor will they be subjected to electrolysis. Furthermore, this technique will remove the potassium and or phosphate from the juices and leave the essential nutrients intact, alleviating the need for reconstituting the juices with calcium or other nutrients

### BRIEF DESCRIPTION OF THE DRAWINGS

So that the above-recited features of the present invention can be understood in detail, a more particular description of the invention, briefly summarized above, may be had by reference to various embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic illustrating the dialysis process.

FIG. 2 is an illustration of an embodiment of an equilibrium dialysis system for removing a particular ion from a dietary liquid, and in particular for removing potassium from such liquid.

FIGS. 3, 4 and 5 are illustrations of the equilibrium dialysis system of FIG. 2 showing the purification process at various stages of completion.

FIG. 6 Illustrates two different chambers/containers separated by a semi-permeable membrane, using the same principle of equilibrium dialysis, which can be used to selectively remove the ions from dietary liquids.

### DETAILED DESCRIPTION OF THE INVENTION

The main principle of the method used to remove ions from liquids is based on equilibrium dialysis. Equilibrium dialysis is being used routinely to remove low molecular weight ions, detergents, etc. from biological samples in a laboratory setting. This technique is used for making purer samples of macromolecules such as DNA and proteins free of other small molecules. Earlier studies on the interaction of DNA with intercalating dyes (ethidium bromide, acridine orange, etc.) have used this technique to remove the unbound dyes from the DNA-DYE complex.

The same principle and technique can be used to remove cations and anions such as potassium and phosphorous from dietary liquids. When a dietary liquid is dialyzed against the same liquid that is lacking a particular anion or cation of the dialysate, then the levels of the anion or cation in the liquid will be reduced after equilibrium dialysis. Various degrees of reduction of the cations and anions can be achieved by manipulating the volume of the dialysate, the duration of dialysis, and the number of times the dietary liquid is subject to the dialysis treatment of this invention. Further, in another embodiment, instead of successive dialysis, the dialysate can be supplied with incremental amounts of the ion exchange resins/ion removers to constantly remove the ions from the dialysate and thus indirectly from the dietary liquid. This can serve to reduce the use of higher volumes of dialysate liquid.

Preliminarily, orange or tomato juice which is rich in potassium can be treated with ion exchange resins to remove potassium. This thus treated juice, now lacking the potassium ions, can be used as dialysate against regular juice in an equilibrium dialysis. Potassium will be distributed between the two juices thus reducing the levels of potassium in the regular juice, but without the loss of other nutrients, at the end of the dialysis process.

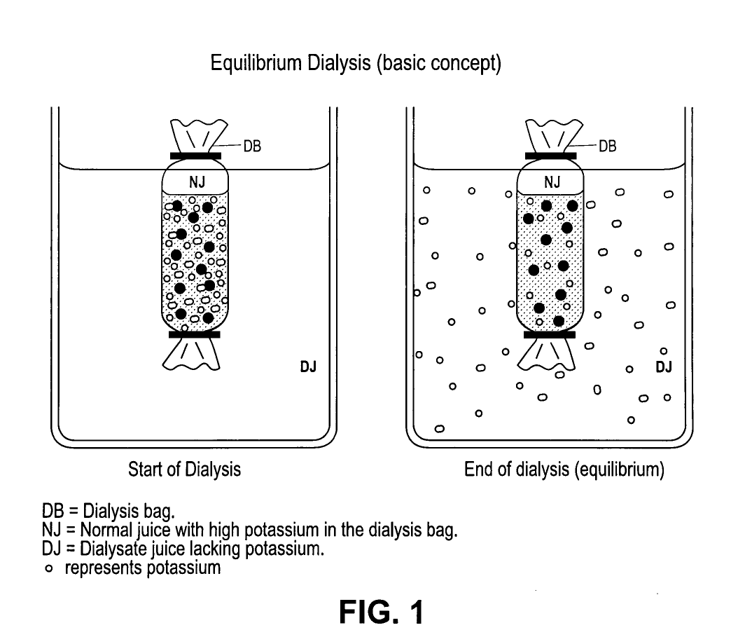

FIG. 1 illustrates this concept. Here, a solution high in concentration of a particular ion (the solution (NJ=normal juice) is placed in the suspended bag made from an osmotic membrane (e.g. a cellulose membrane such as a Spectrapore membrane available from Spectrum Chemicals and Laboratory Products). The juice containing bag is placed into a bath of the same juice solution which has been pretreated using (for example) ion exchange resins (DJ=dialysate juice lacking potassium) to remove the particular ion. Over time the ion will migrate from the fluid of high ion concentration (NJ) to the fluid of low ion concentration (DJ), and if the process is allowed to proceed to completion, the ion concentration will eventually become equal between the two solutions.

The removal of potassium from the fruit juices, dietary liquids etc. can in one embodiment be effected using commercially available proton exchanging resins and calcium exchanging resins, such as calcium resonium (a product containing the active ingredient calcium polystyrene sulfonate), and Amberlite™ IRC-748 resin (available for example from Rohm and Hass, and Supelco-USA). These potassium exchanged (removed) liquids are then used as a dialysate in a dialysis setup.

This equalization process can be performed using a hemodialyzer, or other suitable equipment. To adopt this for commercial production, large tanks will be employed in the order of hundreds or thousands of gallons. It is simply a matter of scale, and no unusual process issues should be presented by such scale up.

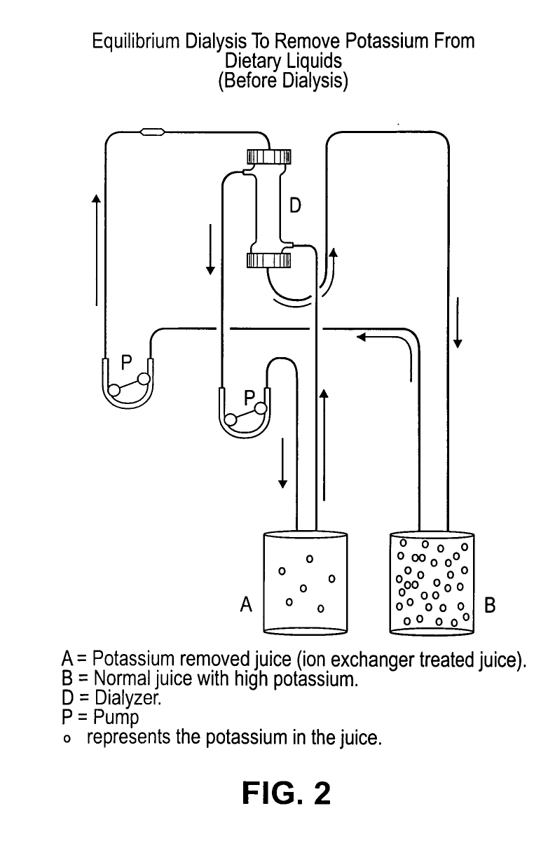

One such system is illustrated in FIGS. 2-5, where the small circles represent an ion such as potassium which is to be removed from the dietary liquid. Here the normal juice (B) is be dialyzed against the potassium removed dialysate juice (A). Unlike hemo-dialysis wherein the dialysate is constantly removed, here both juices (A&B) are recirculated through dialyzer (D) until the equilibrium is attained. The dialysate can be reused for multiple rounds of dialysis. In one embodiment, after equilibrium has been reached, the dialysate can be changed and further dialysis of the normal juice undertaken. This process can be repeated as many times as required until the desired low levels of potassium have been achieved. In another embodiment, the dialysate can be constantly replenished in order to maintain lower levels of potassium, and thus speed up the removal process.

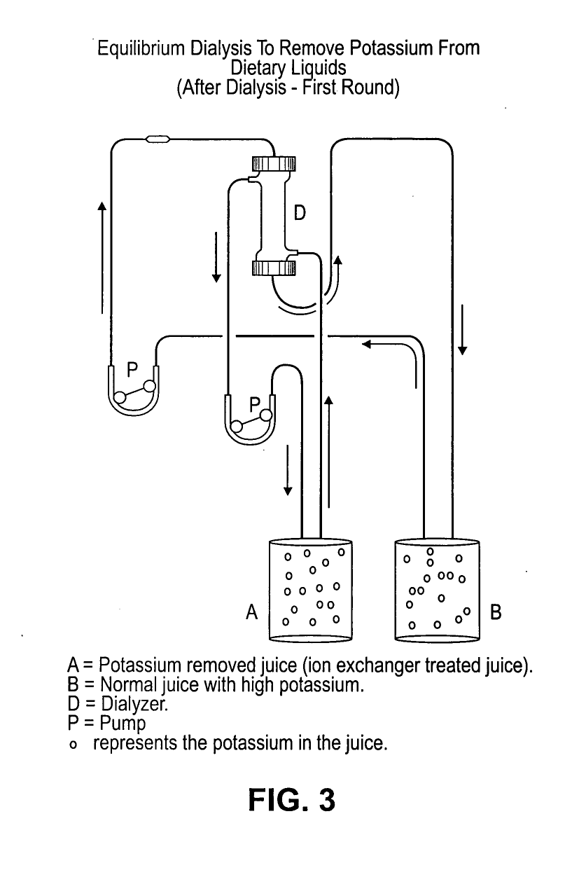

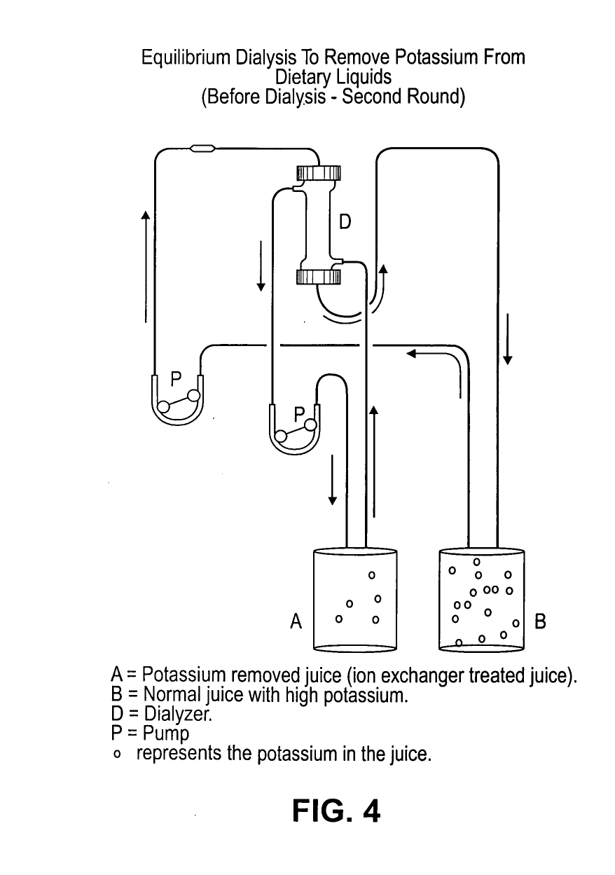

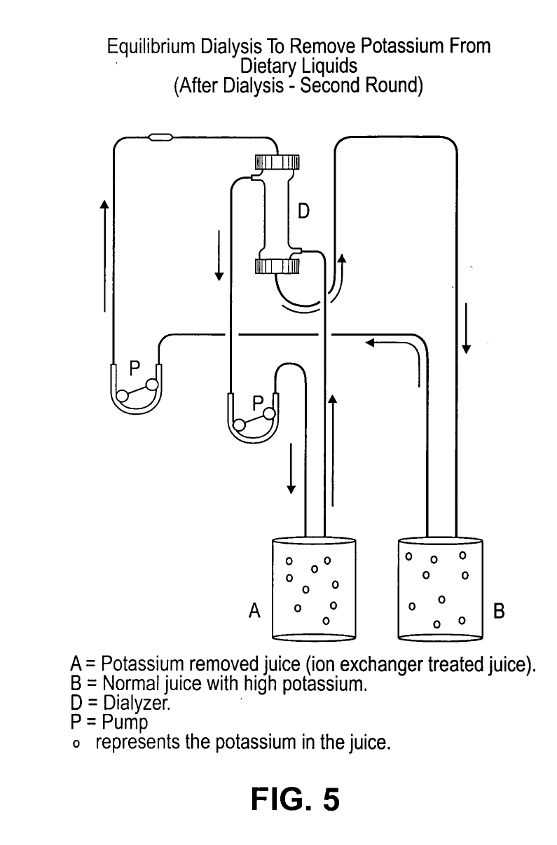

FIG. 2 illustrates a system according to the invention, prior to initiation of the dialysis process, which can begin only after the pumps to the system are turned on and the A and B liquids brought into contact within the Dialyzer D. In FIG. 3, relative concentrations of potassium in the two liquids are shown equally distributed at the end of a first round of dialysis. To reduce the potassium concentration further a second round of treatment is performed. FIG. 4 represents the various potassium concentrations in liquids A and B prior to initiation of the second treatment round, Juice B (with reduced potassium levels) processed against juice A which essentially lacks potassium. Finally in FIG. 5, the process is shown at completion, with juice B having highly reduced levels of potassium.

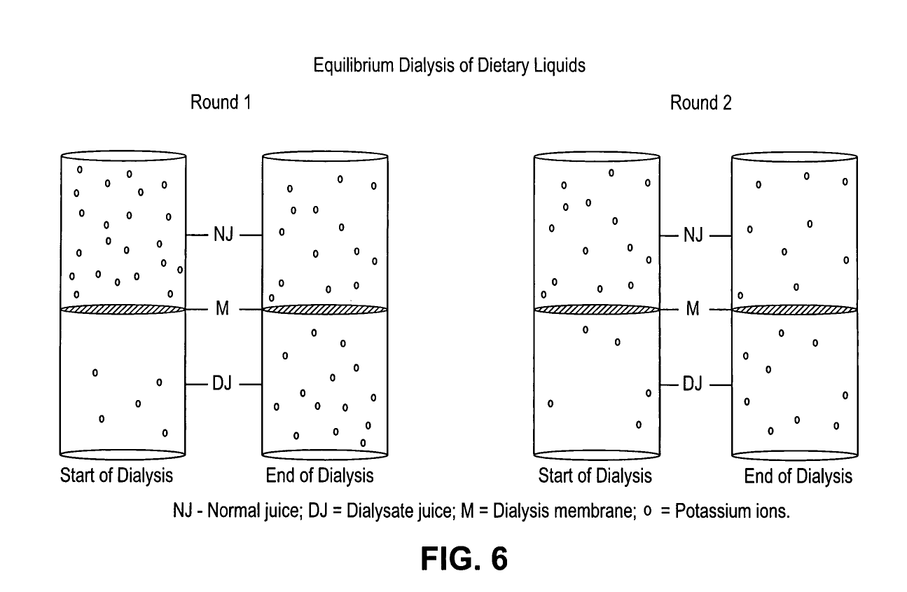

FIG. 6 Illustrates another embodiment of the invention wherein two different chambers/containers are shown separated by a semi-permeable membrane. The removal of unwanted cations or anions from the normal juice relies upon the same principle of equilibrium dialysis to selectively remove the ions from dietary liquids. At the end of round 1, potassium levels are reduced in the normal juice (NJ) and after the second round reduced even further.

As heretofore noted, the presence of excess phosphates in the blood is another major problem faced by kidney patients. Currently, oral intake of phosphate binders along with meals somewhat alleviates this problem. Yet such patients are restricted from consuming dairy products such as milk, baby formula etc. Removing the phosphates from these dietary liquids will be a great help to these patients.

Conditioned alumina has been shown to remove phosphate from milk (U.S. Pat. No. 5,213,835, and Kozumi, T, Murakami, K, Kuwahara, T, and Ohinishi, Y., Preparation of low phosphorous cow's milk. J. Food/Science (2002) 67 2045-2050). Ion exchange resins such as Amberlite® IR A 910 and Amberlite IRA® 410, or similar anion exchangers from Sigma-Aldrich Bohemite (aluminum oxide hydroxide) have also been used to remove phosphorous from mammalian milk (U.S. Pat. No. 5,376,393). Recently, Sevelamer, a hydrogel binder (Renagel from Genzyme), has been shown to reduce the phosphorous levels in milk by about 80% (Ferrara, E, Lemire, J, Reznik, V. M, Grimm, P. C. Dietary phosphorous reduction by treatment of human breast milk with sevelamer. Pediatr. Nephrol (2004) 19, 775-779). Dairy liquids such as milk, buttermilk, baby formula etc. which are devoid of phosphorous can serve as a dialysate in the present technique to remove phosphorous from dairy liquids, similar to removing potassium from the juices. In other words, phosphates can be removed from milk and other dairy liquids by the same equilibrium dialysis techniques as used for potassium, though using dairy liquids lacking phosphates instead as a dialysate. Here again, the milk or any other dairy liquids do not undergo any direct chemical treatment and thus retain their natural quality.

This technology is not meant for just removing potassium and phosphates from dietary liquids. It can be used to remove any other ions or combination of ions using a dialysate lacking those ions

Further, multiple binders or exchangers can be used to remove various cations or anions simultaneously and used as dialysate against the liquids from which these ions have to be removed. For example, both potassium and phosphorous can be removed simultaneously from dairy liquids. The method of this invention allows one to make any specialized liquid lacking any particular anion or cation for any special need for patients or others.

Table 1 below shows the expected values of potassium in a dietary normal juice (designated as NJ) after dialysis. The levels of potassium and the percent reduction when varying volumes of the normal juice are dialyzed against 10 liters of the dialysate juice (treated with ion exchange resin to remove potassium and designated as DJ for dialysate juice) are given. In this example the amount of potassium present in orange juice (˜50 mM) is taken as the pre dialysis level for NJ. The value of 5 mM is assigned for the DJ treated with ion exchange resin.

TABLE 1
First Round of Dialysis

| | | | | K in NJ & | |
|---|---|---|---|---|---|
| Vol. NJ | | Vol. DJ | | DJ after | Reduction |
| (liters) | K in NJ | (liters) | K in DJ | dialysis | in K (%) |
| 1 | 50 | 10 | 5 | 9 | 82 |
| 2 | 50 | 10 | 5 | 12.5 | 75 |
| 3 | 50 | 10 | 5 | 15.4 | 70 |
| 4 | 50 | 10 | 5 | 18 | 64 |
| 5 | 50 | 10 | 5 | 20 | 60 |

TABLE 2
Second Round of Dialysis

| | | | | K in NJ & | |
|---|---|---|---|---|---|
| Vol. NJ | | Vol. DJ | | DJ after | Reduction |
| (liters) | K in NJ | (liters) | K in DJ | dialysis | in K (%) |
| 1 | 9 | 10 | 5 | 5.3 | 89.4 |
| 2 | 12.5 | 10 | 5 | 6.2 | 87.6 |
| 3 | 15 | 10 | 5 | 7.3 | 85.4 |
| 4 | 18 | 10 | 5 | 8.1 | 83.8 |
| 5 | 20 | 10 | 5 | 10 | 80 |

The two tables given above show the expected levels of reduction of potassium when 1 to 5 liters normal juice (NJ) is dialyzed against 10 liters of the juice lacking potassium (treated with ion exchange resins). The levels of potassium in the normal juice (NJ) and the dialysate juice (DJ) are shown as 50 millimoles per liter respectively. When 1 liter of the NJ is dialyzed against 10 liters of the DJ, the levels of potassium in NJ and DJ becomes 9 millimoles per liter at the end of equilibrium dialysis. In other words, the level of potassium from the NJ is reduced from 50 millimoles per liter to 9 millimoles per liter or 82% reduction in the levels of potassium (Table 1; row 1). Thus, varying levels of reduction in potassium in NJ can be achieved when dialyzed against millimoles per liter and 5-10 liters of DJ. Similarly, Table 2 shows how the levels of potassium can be reduced further with successive dialysis. After two rounds of dialysis 1 liter of NJ loses about 90% of potassium when dialyzed against 10 liters of DJ.

At the end of the dialysis the potassium will be distributed between the juices and the concentration of potassium will be the same in NJ and DJ. Based on these calculations, it can be assumed that while the potassium in 1 liter of the NJ can be reduced by about 80% using 10 liters of DJ in one round of dialysis. The same level of reduction can be achieved in 5 liters of NJ by two rounds of dialysis.

In the exchange process, when employing calcium resonium to first create the dialysate juice, potassium from the dietary liquid is replaced with calcium. This newly introduced calcium in the dialysate can transfer to the normal juice in the dialysis process. Because too much calcium can also be a dietary problem for some, an additional chelating agent can be added during the dialysate preparation process to remove this excess calcium. In the further experiments below described, proton exchange resin Amberlite® IRC 748 was used to remove such excess calcium. It is to be appreciated that other agents can be used to remove this calcium, subject to the requirement that the pH of the normal juice remain above 3.0 in order to maintain flavor. The preparation of the dialysate, in one approach can thus be subject to a two step process. In the first step, normal juice is first treated with calcium resonium to reduce its potassium by up to 90%. In the second step, the thus treated juice can be treated with the proton exchanging Amberlite resin. The thus treated dialysate is now ready for use in the equilibrium dialysis process of the invention.

The efficacy of the present invention will now be further detailed by reference to the additional examples. In these examples only commercially available orange juice was used as the dietary liquid, calcium resonium (Sanofi Synthelabo, Australia-Calcium polystyrene sulfonate) as the potassium removing resin and Amberlite IRC748 chelating resin (Supelco-USA) as the agent for removing excess calcium. These examples and the results obtained presented in the form of tables clearly illustrate that equilibrium dialysis can be used to reduce specific ions or elements from any dietary liquid using a range of specific or combination of resins.

### Example 1

This example describes the making of dialysate orange juice lacking potassium from the equilibrium dialysis of normal juice. Here, the treating resin is calcium resonium (a powder containing the active ingredient calcium polystyrene sulphonate), a resin commonly prescribed to absorb potassium from patients with hyperkalemia. In the experiment, 50 ml of commercially available juice (Tropicana orange juice with some pulp) was mixed with the resin at a final concentration of 40, 80, and 160 milligrams of resin per ml of the juice.

The mixing was performed using magnetic stirrer and Teflon coated magnetic bars for 12 hours. After this, the orange juice was centrifuged at 3000 RPM for 10 minutes to remove the resin. The resultant supernatant was analyzed for important elements in the orange juice (Wallace laboratories, El Segundo Calif.). Table 3 gives the results for potassium, sodium, calcium and phosphorous, ions particularly monitored for the kidney patients.

With increasing levels of the resin, more potassium is removed from the juice. Compared to the control juice (no resin added) which has 2159 mg of potassium per liter, the juice treated with 160 mg/ml of the resin showed a significant reduction in potassium levels (658 mg/liter). In order to achieve even further reduction in potassium, successive treatment with 160 mg/ml of the resin was performed.

In this case, normal juice was treated with 160 mg/ml of the resin, after which the juice was spin down and a second round of 160 mg/ml of fresh resin was added to the juice. Similarly a third round of fresh resin treatment was done. The results presented in (Table 3—rows 160(2^{nd} round) and 160(3^{rd} round) show remarkable reduction in the levels of potassium. By the final round, more than 90% of the potassium was removed. The levels of sodium and phosphorous were not significantly altered by this treatment. However, the calcium levels increased greater than 20 fold. This is expected as potassium was exchanged for calcium by the resin calcium resonium.

TABLE 3
Removal of potassium from orange juice
using calcium resonium resin

| Amt. of resin | | | | |
|---|---|---|---|---|
| added (mg/ml) | Potassium | Calcium | Sodium | Phosphorous |
| 0 | 2159.5 \| | 76.2 | 7.0 | 206.1 |
| 40 | 1334.9 | 677.5 | 8.7 | 204.5 |
| 80 | 1032.8 | 1150.0 | 7.8 | 205.8 |
| 160 | 658.5 | 1485.0 | 6.3 | 215.9 |
| 160 (2^{nd} round) | 128.9 | 2185.0 | 11.2 | 258.9 |
| 160 (3^{rd} round) | 39.8 | 2253 | 12.7 | 270.9 |

All the values are expressed as mg/ml of the liter of juice.

### Example 2

In Example 1, with successive addition of calcium resonium more than 90% of the potassium was removed. However, using calcium resonium, the amount of calcium increased from ˜70 mg to 2000 mg. According to Kinishita, et al. (U.S. Pat. No. 6,387,425), which uses proton exchanging resin to remove the level of potassium that is claimed in this application, the addition of solid calcium carbonate or calcium hydroxide was necessary to bring the pH back to original levels. This external addition of calcium would cause excess uptake of calcium by kidney patients for whom the potassium free juices are much needed. However, in consideration of the recent findings that cardiovascular calcification in kidney patients is a major concern (Nolan, C. R., Phosphate binder therapy for attainment of K/DOQI bone metabolism guidelines, Kidney International, Vol. 68, Supplement 96 (2005), pp 7-14), it becomes necessary to avoid excess calcium in their diets. Although calcium based phosphate binders are routinely prescribed for kidney patients, currently the emphasis is on non-calcium based phosphate binders such as Renagel® (Genzyme). This is to avoid cardiovascular calcification in the long run. Thus, while reducing potassium in diets, the levels of calcium should also be controlled without altering the pH. The prior U.S. Pat. No. 6,387,425 does not address this concern. Further, the use of calcium exchange resins in previous arts (see references cited in U.S. Pat. No. 6,387,425) do not achieve the level of reduction of potassium as given in Example 1 by successive use of the resin.

In this example, attempt was made to reduce calcium to a much lower level such that the calcium content falls well below the daily allowance level. Two different proton exchange resins were used to do this. The main purpose is to lower the calcium and at the same time maintain the pH above 3.0. Potassium removed juice from Example 1 was treated with DOWEX™ MARATHON™ MR-3 a biequivalent anion-cation exchanger (Supelco-USA) or Amberlite™ IRC-748 resin (Supelco) which exchanges H⁺ for other cations for 2 hours (80 mg of resin/ml of the juice). After this, the juices were spun down to remove the resins and analyzed for the levels of calcium and other elements. The results are given in table 4. Levels of sodium, potassium and phosphorous remained the same. There is no change in the pH of the juice. Calcium levels were reduced almost 50% in the case of resin IRC-748. However, with Marathon-Mr3 resin calcium level remained the same. Thus illustrating a preference in this case to use IRC-748 to reduce calcium.

TABLE 4
Removal of excess calcium from the potassium
reduced juice using ion exchange resins

| Sample | Potassium | Calcium | Sodium | Phosphorous | pH |
|---|---|---|---|---|---|
| Control juice | 1835.9 | 78.4 | 8.1 | 191 | 3.8 |
| Calcium resonium | 140 | 1876.0 | 6.4 | 224 | 3.6 |
| (after 2 rounds) | | | | | |
| Resin IRC748 | 126 | 1096.0 | 6.7 | 214 | 3.7 |
| (80 mg/ml) | | | | | |
| Dowex Marathon | 142 | 1747.0 | 6.2 | 134 | 3.6 |
| MR-3 resin | | | | | |
| (80 mg/ml) | | | | | |

All the values are expressed as mg/liter of the juice.

### Example 3

In Example 2 by using IRC-748 resin the level of calcium was reduced to ˜1000 mg/liter. In order to further reduce the levels of calcium, higher levels of the resin was used. Table 5 shows the results of such treatment. At the resin concentration of 160 mg/ml, calcium levels were reduced by almost 75% without altering sodium, potassium and phosphorous and still maintaining the pH above 3.0. This level of calcium reduction (500 mg/liter or ˜125 mg/8 oz) achieved here is well within the allowable daily intake of calcium (1500 mg of calcium/day) for kidney patients. Through examples 1 to 3, orange juice with 90% less potassium and with optimal levels of calcium was produced.

TABLE 5
Removal of excess calcium from potassium reduced orange juice

| Sample | Potassium | Calcium | Sodium | Phosphorous | pH |
|---|---|---|---|---|---|
| Potassium | 151.9 | 1926 | 2.05 | 221 | 3.70 |
| reduced orange | | | | | |
| juice | | | | | |
| IRC-748 resin | 125.8 | 502 | 3.4 | 200 | 3.04 |
| (160 mg/ml) | | | | | |
| treatment | | | | | |

All the values are expressed as mg/ml of the juice

### Example 4

Unlike the prior arts wherein the ion exchange resin treated juices were used for consumption, the juices made by Examples 4 to 7 (see below) do not involve direct treatment of the juices with the resins. This is a significant improvement over the prior arts. Equilibrium dialysis between the potassium reduced juices (see examples 1-3) and normal juice will be used to reduce the levels of potassium from the normal juice. For the purpose of clarity normal juice will be referred as NJ and the dialysate juice lacking potassium will hereafter be referred as DJ. First set of equilibrium dialysis were performed with dialysis tubes/bags (Fisher scientific, USA.—Fisher brand dialysis tubings—regenerated cellulose—molecular weight cut off 6000-8000).

Fifty ml of the NJ (Tropicana orange juice) was filled in a clean dialysis tubing. Both ends of the tube were tied and the tube was immersed in 100 ml orange juice with 160 mg/ml of calcium resonium (DJ) in a beaker. The DJ was stirred without disturbing the dialysis bag for 12 hrs. After this, the dialysis tube was removed and kept secured. An aliquot (1 ml) of the NJ was removed from the bag for analysis. The DJ in the beaker was centrifuged at 3000 RPM for 10 minutes to remove the resin. To the clear supernatant fresh calcium resonium was added (160 mg/ml) and mixed well. The NJ in the dialysis bag is again immersed into this and left for 12 hrs with stirring. Another aliquot of the NJ was withdrawn for analyses after this second round of dialysis for analysis. The DJ was spun down as before to remove the resin. To the supernatant IRC-748 resin was added (160 mg/ml) and the dialysis bag was put back in to the DJ and allowed equilibrate for 5 hrs. Samples (1 ml) of NJ in the dialysis bag were withdrawn at 1 hr and 5 hr intervals for analyses. At the end all treatments an aliquot of the DJ was saved for analyses.

The results are presented in table 6. After two rounds of equilibrium dialysis using calcium resonium ˜87% of potassium is removed from the NJ (from 1940 mg to 257 mg/liter). During the same treatment calcium levels in the NJ increased as expected. It has increased form ˜75 mg to ˜940 mg/liter. However, after the third round of dialysis using IRC-748 resin, calcium levels were reduced significantly. The pH of the NJ was still above 3.0. Comparison of the DJ to the NJ at the end of the dialysis suggests that the equilibrium dialysis has worked well. Thus at the end of equilibrium dialysis, which does not involve direct treatment of the juice with resins, orange juice with >90% reduced potassium was produced without changing the other essential components of the juice.

TABLE 6
Equilibrium dialysis of orange juice to remove
potassium using dialysis bag/tubing

| Sample | Potassium | Calcium | Sodium | pH |
|---|---|---|---|---|
| Control juice | 1940 | 74.9 | 5.45 | 3.8 |
| After 1^{st} round of dialysis (NJ) | 737 | 584.0 | 8.73 | 3.5 |
| After 2^{nd} round of dialysis (NJ) | 257 | 937.0 | 4.33 | 3.4 |
| After 1 hr with IRC-748 resin (NJ) | 195 | 687.0 | 3.76 | 3.07 |
| After 5 hr with IRC-748 resin (NJ) | 167 | 332.0 | 5.23 | 3.0 |
| Dialyste juice at the end (DJ) | 164 | 203.0 | 5.59 | 2.98 |

All the values are expressed as mg/ml of the juice

### Example 5

In this example equilibrium dialysis between NJ and DJ was performed using a Nalgene (150 ml) filtering device (Nalge Nunc International, USA.). This device has two chambers, top and bottom, separated by a cellulose acetate membrane. The bottom camber can be attached to a vacuum device so that liquids from the upper chamber can be filtered through the membrane into the bottom chamber. Even though it is a filtering device it can be used for equilibrium dialysis because it has two chambers divided by a membrane. When NJ and DJ are separated by the membrane, there will be an equilibrium dialysis between these two juices.

In this example 200 ml of the DJ (mixed with 160 mg/ml of calcium resonium) was poured into the bottom chamber. It was made sure that the juice is in complete contact with the filtering membrane. The top chamber was filled with 100 ml of NJ and covered with the lid. A small magnetic bar was pushed into the bottom chamber. The whole set up was kept on a magnetic stirrer and left for 12 hrs stirring. After this the NJ was siphoned off carefully and saved. The DJ was drained off carefully from the bottom chamber. The DJ was then spun down to remove the resin. To the supernatant fresh calcium resonium was added (160 mg/ml), mixed well and poured back into the bottom chamber of the filtering device. The saved NJ was poured back into the upper chamber. A 1 ml aliquot was saved from the NJ for analyses after this first round of dialysis. The NJ and DJ were allowed to equilibrate for another 12 hrs. After this NJ and DJ were removed from the chambers and the DJ was spun down to remove the calcium resonium resin. To the supernatant DJ IRC-748 resin was added (160 mg/ml) and put back to the bottom chamber. NJ was poured back to the top chamber. A 1 ml aliquot of NJ was saved for analysis. The juices were allowed equilibrate for 5 hrs. At 1 hr and 5 hr time period 1 ml aliquots of NJ were saved for analysis.

The results are presented in table 7. After two rounds of equilibrium dialysis, ˜90% of the potassium in NJ was removed. Calcium levels increased from 75 mg to 1170 mg/liter during the same period. With the third round of dialysis using IRC-748 resin reduced the levels of calcium to about 250 mg/liter. The levels of sodium were not altered much during this process. The pH of NJ is still maintained above 3.0. This example clearly show that a device in which two compartments separated by a membrane can be used for equilibrium dialysis of juices.

TABLE 7
Equilibrium dialysis of orange juice to remove
potassium using dialysis membrane/filter

| Sample | Potassium | Calcium | Sodium | pH |
|---|---|---|---|---|
| Control juice (before dialysis) | 1940 | 74.9 | 5.45 | 3.80 |
| After 1^{st} round of dialysis (NJ) | 804 | 847.0 | 10.70 | 3.40 |
| After 2^{nd} round of dialysis (NJ) | 213 | 1169.0 | 2.62 | 3.30 |
| After 1 hr with IRC-748 resin (NJ) | 257 | 206.0 | 6.35 | 3.02 |
| After 5 hr with IRC-748 resin (NJ) | 207 | 201.0 | 2.70 | 2.9 |

All the values are expressed as mg/liter of the juice.

### Example 6

In this example hemo-dialyzers were used to perform the equilibrium dialysis. Hemo-dialyzers are medically proven and FDA approved devices to treat kidney patients to get rid of their toxic substances from their blood. In hemo-dialysis the dialysate fluid is constantly removed while the blood is re-circulated through the dialyzer as and when the dialysis happens. However, when this device is used with NJ as the fluid to be dialyzed (similar to blood) and with the DJ as dialysate fluid, both the juices can be re-circulated, and an equilibrium can be achieved between the NJ and DJ. Thus one can reduce the levels of potassium in the NJ without significant alteration of other components.

A polyflux dialyzer (Polyflux capillary dialyzer-type H170-Gambro-Germany) with cellulose acetate membrane as a molecular sieve was used for this example. The outer jacket was circulated with the DJ, and the NJ was circulated through the inner chamber. Approximately 425 ml of the orange juice mixed with 80 mg/ml of calcium resonium resin and circulated as dialysate fluid. 200 ml of NJ was circulated through the inner chamber. The juices were pumped through the dialyzer using a peristaltic pump (Cole-Palmer.USA) with a pumping speed of 120 ml/min and let dialyze for 12 hrs. At the end of this dialysis, a 10 ml aliquot of the NJ was saved for analysis and the DJ was drained out and spun down to remove the resin. To the supernatant DJ fresh batch of calcium resonium was added (80 mg/ml) and the DJ was circulated again. The dialysis was continued for another 12 hrs. After the second round of dialysis 10 ml of NJ was analyzed for various elements. In this preliminary attempt the two step dialysis was performed to see if the dialyzer can be used for equilibrium dialysis to remove potassium from NJ.

The results are presented in Table 8. After the first round of dialysis, there is a 50% reduction in the levels of potassium and with second round of dialysis almost 70% of the potassium has been removed from the NJ. However, there is not much change in the levels of sodium and phosphorous and the pH remained above 3.0. As expected the calcium levels went up. This example has proven that hemo-dialyzer can be used to reduce potassium in dietary juices.

TABLE 8
Equilibrium dialysis to remove potassium using hemo-dialyzer

| Sample | Potassium | Calcium | Sodium | Phosphorous | pH |
|---|---|---|---|---|---|
| Control juice | 1908 | 71.7 | 2.51 | 173 | 3.7 |
| After 1^{st} round | 1099 | 1425.0 | 2.16 | 177 | 3.4 |
| of dialysis (NJ) | | | | | |
| After 2^{nd} round | 571 | 1257.6 | 5.77 | 153 | 3.4 |
| of dialysis (NJ) | | | | | |

All the values are expressed as mg/liter of the juice

### Example 7

In this example equilibrium dialysis was performed as described in Example 6 with two modifications. The level of calcium resonium was increased from 80 mg/ml to 160 mg/ml in the DJ. And a third round of dialysis was performed with resin IRC 748 (160 mg/ml) for three hours to remove excess calcium from the juice. At the end of each round of dialysis 10 ml aliquots of the NJ was saved for analysis.

The results are given in table 9. With two rounds of dialysis with calcium resonium almost 90% of potassium has been removed in the NJ. With the additional round of dialysis with IRC-748 for three hours, the calcium was reduced to about 400 mg/liter of the juice. This would amount to about 100 mg Calcium in an 8 oz size of this juice.

TABLE 9
Equilibrium dialysis to remove potassium using hemo-dialyzer

| Sample | Potassium | Calcium | Sodium | Phosphorous | pH |
|---|---|---|---|---|---|
| Control juice | 1924 | 79 | 4 | 175 | 3.7 |
| (before dialysis) | | | | | |
| After 1^{st} round | 420 | 1239 | 2.9 | 181 | 3.5 |
| of dialysis | | | | | |
| After 2^{nd} round | 214 | 1463 | 2 | 78 | 3.3 |
| of dialysis | | | | | |
| After IRC-748 | 203 | 403 | 2 | 78 | 3.1 |
| treatment (3 hrs) | | | | | |

All the values are expressed as mg/liter of the juice.

It is to be appreciated that the processes of this invention are useful for the purification of many turbid juices such tomato or vegetable juices, as well as orange juice, the purification principles equally applicable. Unlike the previous methods of using the resins to remove ions, this is a two-step process of removing ions using ion exchange resins followed by equilibrium dialysis. Thus, since the ions from the dietary liquid are removed through dialysis and not by the ion exchange resins directly, there is no need to filter the juices as in prior art.

The most important aspect of this combined ion exchange and dialysis technique is that the dietary liquid that is to be consumed neither comes in contact with any resin nor subjected to any other chemical treatment directly as in the previous technologies. Thus the juice or dietary liquid is as pure as the natural one.

It is to be appreciated that the dialysates can be prepared as part of the equilibrium dialysis process or before. In the first instance, the juice to be used as the dialysate is placed to one side of the dialysis membrane, and the ion exchange resin such as calcium resonium added. The dietary juice to be treated for removal of potassium can thereafter be brought into proximity of the dialysis membrane. In another embodiment, the dialysate forming process can take place remotely, where after treatment, the calcium resonium is filtered out, and the thus filtered dialysate used in the equilibrium process. As for the second phase where excess calcium is removed for the treated juice, the dialysate containing the calcium removing resin, such as Amberlite IRC 748 can be added to the dialysate as part of the equilibrium osmosis step, or can be added separately and then filtered out before the dialysate is used in the equilibrium process to remove calcium. As a still further possibility, both the potassium removing agent and the calcium removing agent can be added together to the dietary liquid to be used to form the dialysate. All such variations in treatment options are possible without departing from the scope of the invention.

While the foregoing is directed to embodiments of the present invention, still other and further embodiments of the invention may be devised without departing from the basic scope thereof, and the scope thereof is determined by the claims that follow.

1. A method for removing an ion of interest from a dietary liquid comprising the steps of:
a. treating a first portion of the dietary liquid to remove the said ion of interest, the thus treated liquid used as a dialysate;
b. bringing the dietary liquid to be treated into proximity with the dialysate, the two liquids separated by an osmotic or semi-permeable membrane; and,
c. maintaining the two liquids in contact while separated by the said membrane until an equilibrium concentration of the ion of interest is reached.

2. The method of claim 1 wherein the two liquids are brought into proximity which each other in a dialyzer.

3. The method of claim 1 wherein the first portion of dietary liquid, used as the dialysate, is treated with an ion exchange resin to remove the ion of interest.

4. The method of claim 3 where the first portion of the dietary liquid, used as the dialysate is first filtered to remove the ion exchange resin prior to its being used by being brought into proximity with the osmotic member which separates the dialysate from the dietary liquid to be treated.

5. The method of claim 1 wherein the ion of interest is potassium.

6. The method of claim 1 wherein the ion of interest is a phosphate

7. The method of claim 5, the dialysate is first treated with the ion exchange resin calcium resonium (calcium polystyrene sulfonate).

8. The method of claim 7 wherein following treatment of the dialysate to remove potassium, the dialysate is further treated with an ion exchange resin to remove calcium.

9. The method of claim 7 wherein the ion exchange resin used to remove calcium is Amberlite® IRC-748 resin from Rohm and Hass.

10. The method of claim 6 wherein, the dialysate is first treated with the ion exchange resin to remove phosphates.

11. The method of claim 10 wherein the ion exchange resin is selected from the group comprising Amberlite® IR A 910 and Amberlite®R IRA 410, or similar anion exchangers from Sigma-Aldrich Bohemite (aluminum oxide hydroxide), and Sevelamer (Renagel from Ggenzyme).

12. The method of claim 1 wherein the dietary liquid contains two different ions of interest and removal of these ions from the dietary liquid is conducted simultaneously.

13. The method of claim 12 wherein the dialysate liquid is treated prior to dialysis to remove both ions of interest.

14. The method of claim 12 wherein the removal of each of the ions of interest is conducted in sequential steps wherein the dietary liquid is first brought into contact with the dialysate from which one of the ions of interest has been removed, the two liquids separated by an osmotic membrane, and thereafter the dietary liquid brought into contact with a second dialysate from which the other ion of interest has been removed.
